(19) United States
(12) Patent Application Publication
(10) Pub. No.: US 2026/0340325 A1
(43) Pub. Date: Oct. 29, 2026

(54) RADIO FREQUENCY IDENTITY (RFID) TAG LOCATION BASED ON BACKSCATTER RECEIVED BY RFID TAG READER

(71) Applicant: T-Mobile Innovations LLC, Overland Park, KS (US)

(72) Inventors: Robert K. Butler, Overland Park, KS (US); Zheng FANG, Mclean, VA (US); Pei HOU, Centreville, VA (US); Ankit Muchhala, Leesburg, VA (US)

(21) Appl. No.: 19/190,580

(22) Filed: Apr. 25, 2025

(51) Int. Cl. G06K 7/10

(52) U.S. Cl. CPC G06K 7/10128

(57) ABSTRACT

A radio frequency identity (RFID) tag reader. The reader comprises an antenna; a radio transceiver coupled to the antenna; a memory; a processor coupled to the radio transceiver and to the memory; and an application stored in a non-transitory portion of the memory that, when executed by the processor transmits a radio sounding signal to an RFID tag, receives a radio backscatter signal from the RFID tag, analyzes the radio backscatter signal to determine a received signal strength indication (RSSI) of the backscatter signal, analyzes the radio backscatter signal to determine a phase offset of the received radio backscatter signal, and determines a location of the RFID tag based on the RSSI and the phase offset.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Radio frequency identity (RFID) tags are passive semiconductor devices that may be affixed to various items for conducting electronic scans and inventory control functions. The RFID tags typically do not have self-contained electric power sources and harvest electrical power from ambient radio frequency fields. When powered and/or hailed by an RFID tag reader device, the RFID tags may broadcast information wirelessly via an antenna and radio transmitter on-board the RFID tag.

### SUMMARY

In an embodiment, in a radio frequency identity (RFID) tag reader is disclosed. The RFID tag reader comprises an antenna; a radio transceiver coupled to the antenna; a memory; a processor coupled to the radio transceiver and to the memory; and an application stored in a non-transitory portion of the memory. When executed by the processor, the application transmits a radio sounding signal to an RFID tag, receives a radio backscatter signal from the RFID tag, analyzes the radio backscatter signal to determine a received signal strength indication (RSSI) of the backscatter signal, analyzes the radio backscatter signal to determine a phase offset of the received radio backscatter signal, and determines a location of the RFID tag based on the RSSI and the phase offset.

In another embodiment, a radio frequency identity (RFID) tag reader is disclosed. The RFID tag reader comprises an antenna; a radio transceiver coupled to the antenna; a memory; a processor coupled to the radio transceiver and to the memory; and an application stored in a non-transitory portion of the memory. When executed by the processor, the application directs a beam of the antenna in a first direction, transmits a radio sounding signal in the first direction, receives a radio backscatter signal from an RFID tag, analyzes the radio backscatter signal to determine a received signal strength indication (RSSI) of the backscatter signal, determines a distance from the RFID tag reader to the RFID tag based on the RSSI and the phase offset, and determines a location of the RFID tag based on the first direction and based on the distance from the RFID tag reader to the RFID tag.

In yet another embodiment, a method of locating radio frequency identity (RFID) tags by a RFID tag reader is disclosed. The method comprises, for each of a plurality of reference tags in an environment, associating a known location in the environment to the reference tag; transmitting a radio sounding signal by the RFID tag reader to each of the plurality of reference tags; and receiving a radio backscatter signal by the RFID tag reader from each of the plurality of reference tags. The method further comprises analyzing the radio backscatter signals by the RFID tag reader to determine a radio backscatter signature for each of the plurality of reference tags and associating the radio backscatter signature of each of the plurality of reference tags by the RFID tag reader to the known location in the environment of the reference tags in a reference map. The method further comprises transmitting a radio sounding signal by the RFID tag reader to an RFID tag in the environment; receiving a radio backscatter signal by the RFID tag reader from the RFID tag in the environment; analyzing the radio backscatter signal by the RFID tag reader to determine a radio backscatter signature of the RFID tag; comparing the radio backscatter signature of the RFID tag by the RFID tag reader to all the radio backscatter signatures in the reference map to determine a best match; and estimating a location of the RFID tag by the RFID tag reader based on the known location of the reference tag associated with the best match radio backscatter signature.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a system according to an embodiment of the disclosure.

FIG. 2 is a block diagram of another system according to an embodiment of the disclosure.

FIG. 3 is a block diagram of yet another system according to an embodiment of the disclosure.

FIG. 4 is an illustration of radio waves arriving out-of-phase at two antenna elements and a derivation of an equation for determining a direction to a radio emitter based on the phase offset according to an embodiment of the disclosure.

FIG. 5A and FIG. 5B is a flow chart of a method according to an embodiment of the disclosure.

FIG. 6 is a block diagram of a computer system according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

Currently, RFID tag readers typically read information from RFID tags affixed to product packages but do not attempt to automatically determine a location of the RFID tags. In some cases, it may be desirable for readers to automatically determine locations of RFID tags and be able to link that location information to the other information read from the RFID tags (e.g., a product identity, an identity of an original equipment manufacturer (OEM) of the product, a manufacture date of the product, a receipt date of the product, and an electronic serial number of the RFID tag). The present disclosure teaches an RFID tag reader that uses one or more techniques and/or tactics to estimate or determine a location of RFID tags.

In an embodiment, the RFID tag reader determines a coarse distance to an RFID tag based on backscatter received from an RFID tag. The RFID tag reader transmits a radio signal of known signal strength (known to the RFID tag reader since it transmits the signal), the RFID tag is configured to backscatter the radio signal, and the RFID tag reader receives the backscattered radio signal. The RFID tag reader can then determine the received signal strength indication (RSSI) of the backscattered radio signal and estimate a distance to the RFID tag based on the backscatter RSSI and based on well-known backscatter signal strength formulas. The RFID tag reader further can analyze a phase of the backscatter signal to determine a phase-offset of the backscattered radio signal. The coarse distance to the RFID tag can be estimated based on the RSSI to within the limits of a wavelength, and the phase offset can be used to arrive at a more precise estimate of the distance to the RFID tag. In some use cases, knowing the distance from the RFID tag reader to the RFID tag may be sufficient.

In other cases, however, a direction to the RFID tags is also desirably automatically determined. In an embodiment, the RFID tag reader can direct a beam of an antenna of the RFID tag reader towards the RFID tag and thereby determine a direction to the RFID tag. With a known angular direction to the RFID tag relative to the position of the RFID tag reader and with a known distance to the RFID tag from the RFID tag reader, the location of the RFID tag is determined (e.g., is determined by a pair of polar coordinates). In particular, the RFID tag reader can continuously or repeatedly transmit a radio sounding signal, sweep the antenna beam through an angular arc, receive backscatter signals from the RFID tag, and determine RSSIs of the backscatter signals from the RFID tag. When the RSSI is maximum, the RFID tag reader can infer that the beam of an antenna of the RFID tag reader is directed towards the RFID tag.

In an embodiment, one or more reference RFID tags may be located in an environment, for example in a warehouse or in a fulfillment center. The reference RFID tags may be installed at known locations and the identities of the reference RFID tags associated with their known locations in a map or table. One or more of the RFID tag readers in the environment may then estimate the locations of the reference RFID tags using the methods described above. Each RFID tag reader may then store the estimated locations of the reference RFID tags along with the known locations of the reference RFID tags in the map or table. Later, when the RFID tag reader attempts to locate a RFID tag based on its backscatter signal as described above, the RFID tag reader may access the map of reference RFID tags, determine a reference RFID tag whose estimated location best matches the estimated location of the RFID tag, and improve its estimation of the location of the RFID tag based on the known location of the reference RFID tag. In an embodiment, the RFID tag location may be set to be the known location of the reference RFID tag. In an embodiment, the estimated location of the RFID tag may be adapted based on a difference between the known location of the nearest reference RFID tag and the estimated location of the nearest reference RFID tag.

In an embodiment, reference RFID tags may be affixed to storage bins, and product packages having RFID tags affixed to them may be stored in the storage bins. In this case, the known location of the reference RFID tags may further be associated in the map to a bin identity. When the estimated location of an RFID tag is close to the estimated location of a reference RFID tag, the identity of the bin associated with that reference RFID tag may be associated to the RFID tag. The bin identity may be used, for example, in picking products for order fulfillment and/or for performing inventory counts of products.

The system and methods of determining locations of RFID tags described above provides a particular technical solution to a problem in product and/or material tracking technology. The problem is the location of RFID tags in an environment. This particular technical solution can help improve the management of inventory in a warehouse, including locating products that have been misplaced within the environment.

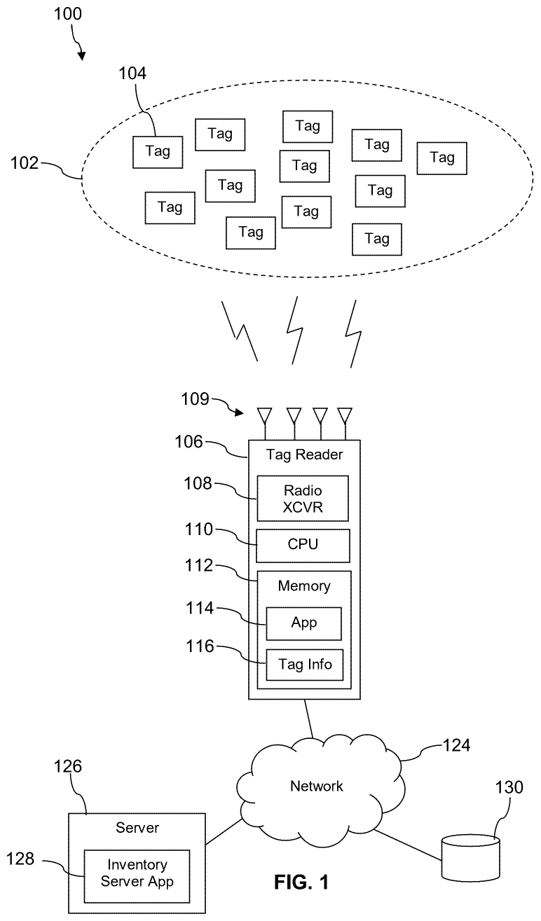

Turning now to FIG. 1, a system 100 is described. In an embodiment, system 100 comprises an environment 102 that encloses a plurality of RFID tags 104. The RFID tags 104 may be affixed to products and/or product packages that are located within the environment 102. In an embodiment, the environment 102 may be a warehouse or a fulfillment center. The system 100 further comprises an RFID tag reader 106. The reader 106 may be considered to be located within the environment 102 and/or be part of the environment 102. While one RFID tag reader 106 is illustrated in FIG. 1, it is understood that the system 100 may comprise a plurality of RFID tag readers 106.

The tag reader 106 may comprise a radio transceiver 108 communicatively coupled to an antenna 109. The antenna 109 may comprise a plurality of antenna elements. In an embodiment, the antenna 109 may comprise two antenna elements, three antenna elements, four antenna elements, five antenna elements, six antenna elements, seven antenna elements, eight antenna elements, nine antenna elements, or ten antenna elements. In an embodiment, the antenna 109 may comprise at least eleven antenna elements and less than fifty antenna elements. In an embodiment, the antenna comprises more than two antenna elements and less than fifty antenna elements. In an embodiment, the antenna comprises more than three antenna elements and less than ten antenna elements. The antenna elements may comprise dipoles. The antenna elements may comprise slots in a slot antenna array. In an embodiment, the antenna 109 is configured to be directionally steered by the radio transceiver 108 (e.g., a beam of the antenna 109 can be formed and steered under control of the radio transceiver 108). The radio transceiver 108 may adapt the communicative coupling with the antenna 109 whereby to cause the antenna 109 to generate a focused beam and to steer the antenna beam in desired directions. For example, the radio transceiver 108 can introduce phase offsets in signals sent to antenna elements to generate a focused antenna beam and steer the antenna beam in a desired direction.

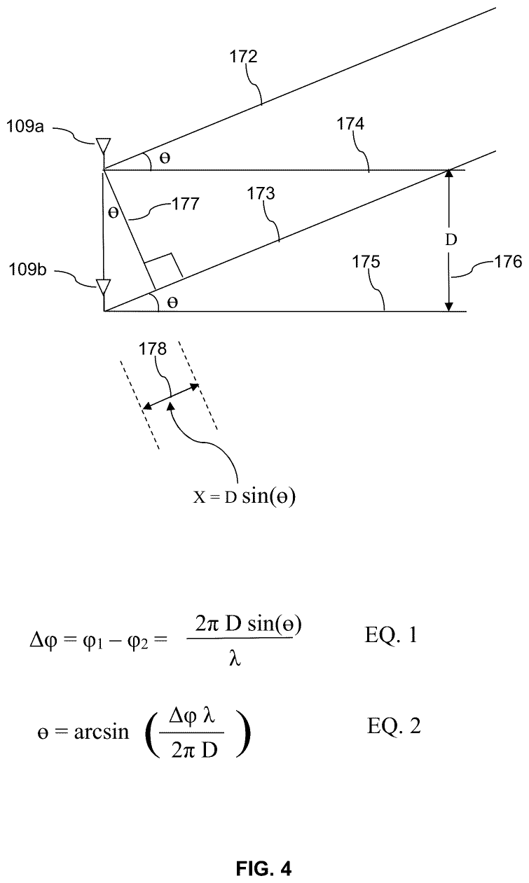

It is understood that the antenna 109 is a reciprocal device and that the antenna beam forming and steering applies to both transmission and to reception activities. In an embodiment, the antenna 109 may operate using circular polarization. In an embodiment, the radio transceiver 108 and/or the tag reader application 114 is able to determine phase offsets between radio signals received at different antenna elements and to determine, thereby, an angular direction to the emitter of the radio signal (e.g., to an RFID tag 104). For further information on determining a direction to an RFID tag 104 based on phase offsets between received radio signals, see FIG. 4 and associated description of FIG. 4 provided hereinafter. In an embodiment, the radio transceiver 108 and/or the tag reader application 114 is able to determine a direction to an RFID tag 104 by sending a plurality of sounding radio signals to the RFID tag 104 while sweeping the beam of the antenna 109 across the RFID tag 104. The direction the beam is steered towards when the radio transceiver 108 receives the strongest radio backscatter signal from the RFID tag 104 (e.g., the highest value RSSI) is the estimated direction towards the RFID tag 104. The combination of an estimated distance to the RFID tag 104 and an estimated direction towards the RFID tag 104 constitutes a location of the RFID tag 104, for example a location in polar coordinates (a radius combined with an angular direction).

The RFID tag reader 106 further comprises a processor 110 and a memory 112. A non-transitory portion of the memory 112 stores a tag reader application 114 that may be executed by the processor 110 to steer the antenna beam of the antenna 109, to transmit an electrical power electromagnetic field to RFID tags 104, to transmit commands to RFID tags 104, and to receive information from the RFID tags 104. The tag reader application 114 may also be able to determine a location of RFID tags 104 in the environment 102.

The RFID tag reader 106 may be communicatively coupled to a network 124. The reader 106 may be coupled to the network 124 via a wired communication link, for example by a wired Ethernet connection. The reader 106 may be communicatively coupled to the network 124 by a wireless communication link. The network 124 comprises one or more private networks, one or more public networks, or a combination thereof. The RFID tag reader 106 may communicate with an application 128 executing on a computer 126. The RFID tag reader 106 may read information from the RFID tags 104 and transmit the RFID tag information to the application 128, for example an inventory control application that executes on the computer 126. In an embodiment, the RFID tag reader 106 may read the information from the RIFD tags 104 and store this as tag information 116 in the memory 112 before transmitting the tag information 116 to the application 128. Computer systems are described further hereinafter. The RFID tag reader 106 can also be viewed as a computer system, albeit with some special features such as the antenna 109 and radio transceiver 108 that may not be typical of many computer systems. The system 100 also comprises a data store 130. The RFID tag reader 106 may also determine locations of one or more of the RFID tags 104 and transmit those locations to the application 128.

Each of the RFID tags 104 may store information. The RFID information may comprise one or more of an identity of a product (e.g., an electronic product code), an identity of an original equipment manufacturer (OEM) of the product, a date of manufacture of the product, a receipt date (e.g., a date the product was received into the environment 102), and an electronic serial number of the product (e.g., a tag identity (TID)). It is to be noted that the identification of the product of a given RFID tag 104 may be shared with a plurality of other RFID tags 104 (e.g., there may be many instances of the same model of smart phone in a fulfillment center) while the electronic serial number of the given RFID tag 104 may be unique. In an embodiment, the RFID information may comprise transaction information, such as transactions performed on a product associated with the RFID tag 104. These transactions may comprise moving the RFID tag 104 (and product to which the tag is affixed) within the environment 102, state changes of the RFID tag 104, and storage conditions experienced by the RFID tag 104 (and product to which the tag is affixed) such as temperature, humidity, irradiation by an ultraviolet source.

In an embodiment, the RFID tag 104 is a passive RFID tag 104, meaning it has no autonomous electric power source and receives electric power via its one or more antenna from an ambient radio frequency electromagnetic field. The ambient radio frequency electromagnetic field may be generated by one or more of the reader 106 or by another power emitter within the environment 102.

The reader 106 may periodically prompt the RFID tags 104 to transmit their information (e.g., product identity, OEM identity, date of manufacture, receipt date, and/or electronic serial number). The readers 106 may transmit a hailing signal to the RFID tags 104 to prompt them to transmit their information. In an embodiment, the reader 106 may transmit radio signals to and receive radio signals from the RFID tags 104. In an embodiment, the reader 106 may transmit radio signals to and receive radio signals from the RFID tags 104 in a cellular radio frequency band. It is understood that cellular radio frequency bands and/or segments of cellular radio frequency bands may be allocated to specific parties (e.g., cellular communication service providers such as AT&T, Verizon, T-Mobile, and others) and that these parties may be allowed to transmit radio signals at higher power levels in their allocated spectrum bands than is permitted in unlicensed radio spectrum bands, for example in the unlicensed ISM radio spectrum bands. Transmitting radio signals at higher power levels may promote improved reception of these signals and may promote communicating at greater distances than would be possible at lower radio transmission power levels.

In an embodiment, the RFID reader 106 may transmit electric power to RFID tags 104 in an electromagnetic field in the 860 MHz to 960 MHz frequency range In an embodiment, the RFID reader 106 may transmit electric power to RFID tags 104 in an electromagnetic field in the 860 MHz to 870 MHz frequency range. In an embodiment, the RFID reader 106 may transmit electric power to RFID tags 104 in an electromagnetic field in the 862 MHz to 869 MHz frequency band. In an embodiment, the RFID reader 106 may transmit electric power to RFID tags 104 in an electromagnetic field in the 2.40 GHz to 2.55 GHz range. In an embodiment, the RFID reader 106 may transmit electric power to RFID tags 104 in an electromagnetic field in the 2.496 GHz to 2.5 GHz range. In an embodiment, the RFID reader 106 may transmit command messages to RFID tags 104 in the 860 MHz to 960 MHz frequency range. In an embodiment, the RFID reader 106 may transmit command messages to RFID tags 104 in the 860 MHz to 870 MHz frequency range. In an embodiment, the RFID reader 106 may transmit command messages to RFID tags 104 in the 862 MHz to 869 MHz frequency range. In an embodiment, the RFID reader 106 may transmit command messages to RFID tags 104 in the 2.40 GHz to 2.55 GHz frequency range. In an embodiment, the RFID reader 106 may transmit command messages to the RFID tags 104 in the 2.496 GHz to 2.5 GHz frequency range.

The RFID tag reader 106 can determine the location of one or more of the RFID tags 104. For example, the RFID tag reader 106 can send a radio sounding signal to the RFID tag 104, the RFID tag 104 may be configured in a backscatter mode of operation, and the antenna of the RFID tag 104 can backscatter the radio signal transmitted by the RFID tag reader 106. Based on the backscatter radio signal received by the RFID tag reader 106, the application 114 can determine a distance to the subject RFID tag 104. For example, the RFID tag reader 106 can determine a received signal strength indication (RSSI) of the backscatter radio signal and estimate a distance from the RFID tag reader 106 and the RFID tag 104 based on comparing the known signal strength of the radio signal emitted by the RFID tag reader 106 to the RSSI of the backscatter radio signal.

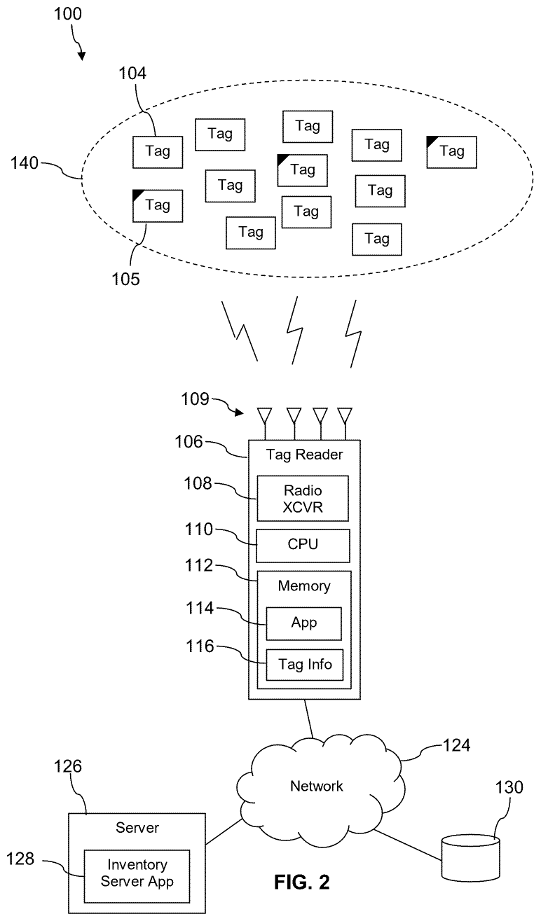

Turning now to FIG. 2, an environment 140 is described. In an embodiment, the RFID tag reader 106 is located within the environment 140. The environment 140 is substantially similar to the environment 102 described above with reference to FIG. 1, but environment 140 comprises a plurality of reference RFID tags 105 in addition to the RFID tags 104. The reference RFID tags 105 may be affixed to statically located structures in the environment 140 and may not be affixed to product packages. The physical locations of the reference RFID tags 105 may be determined and stored in the data store 130. The RFID tag reader 106 can then estimate the location of each of the reference RFID tags 105 and store, determine an offset of the estimated location of the reference RFID tags 105 with the determined locations of the reference RFID tags 105. Later, when the RFID tag reader 106 attempts to locate RFID tags 104, the RFID tag reader 106 and/or the RFID tag reader application 114 can use the information about the location of the reference RFID tags 105 and/or the offset of the estimated location of the reference RFID tags 105 and the determined locations of the reference RFID tags 105 to improve their estimation of the location of the RFID tag 104. For example, if the RFID tag reader application 114 determines that its estimated location of each of the reference RFID tags 105 differs by 5 angular degrees from the determined location of the reference RFID tags 105, the application 114 can infer that its estimated location of the RFID tags 105 likewise differs by 5 angular degrees from the actual location of the RFID tags 104 and correct their estimate accordingly.

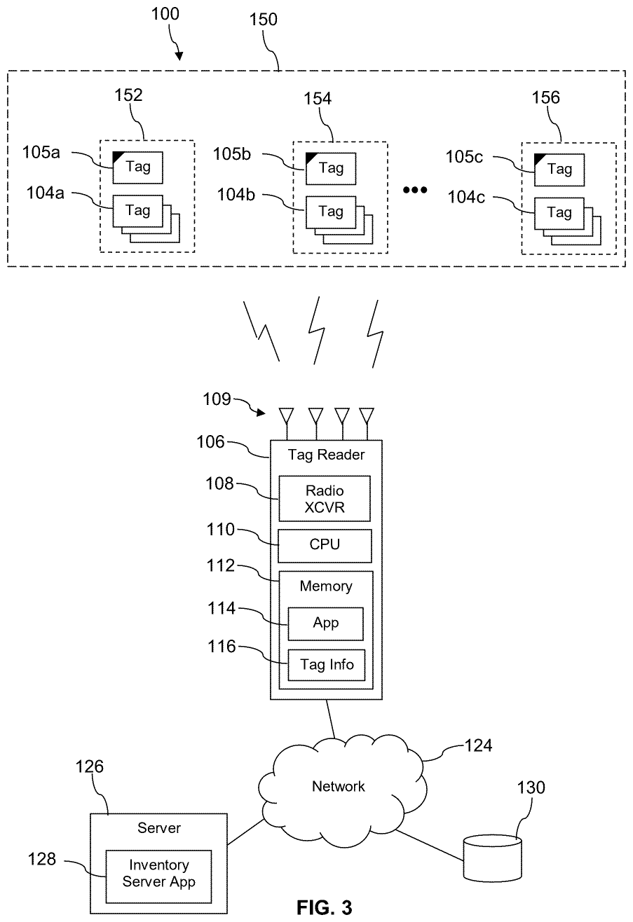

Turning now to FIG. 3, an environment 150 is described. In an embodiment, the RFID tag reader 106 is located within the environment 150. The environment 150 is substantially similar to the environment 140 described above with reference to FIG. 2, but in environment 140, the reference RFID tags 105 are associated with product bins. For example, a first reference RFID tag 105a is affixed to a first product bin 152 that stores a first plurality of products, where each one of the first plurality of products has an RFID tag 104a affixed to it; a second reference RFID tag 105b is affixed to a second product bin 154 that stores a second plurality of products, where each of the second plurality of products has an RFID tag 104b affixed to it; and a third reference RFID tag 105c is affixed to a third product bin 156 that stores a third plurality of products, where of the third plurality of products has an RFID tag 104c affixed to it. When the RFID tag reader 106 attempts to locate an RFID tag 104, it estimates the position of the RFID tag, based on this position estimate determines a reference RFID tag 105 that is closest to the estimated position of the RFID tag, determines what product bin 152, 154, 156 that reference RFID tag 105 is associated to, and concludes that the position of the given RFID tag 104 is in the product bin 152, 154, 156 thus determined. In this way, the location of RFID tags 104 and the products they are affixed to are expressed in terms of the identity of the containing product bin 152, 154, 156. In many cases, knowing the identity of the product bin 152, 154, 156 a given product is located in is the desired information, for example information needed to pick a product package and fulfill a customer order.

Turning now to FIG. 4, an approach to determining a direction from an RFID tag reader 106 to an RFID tag 104 based on a phase offset between backscatter signals received at the antenna elements of the antenna 109 of the RFID tag reader 106 is described. It will be appreciated that this discussion describes one theoretical approach to determining a direction from the RFID tag reader 106 to the RFID tag 104 based on a phase offset between backscatter signals and that it is contemplated that the RFID tag reader 106 and/or the RFID tag reader application 114 may use another different approach to determine a direction from the RFID tag reader 106 to the RFID tag 104. As illustrated in FIG. 4, a first radio backscatter signal 172 arrives at a first antenna element 109a and a second radio backscatter signal 173 arrives at a second antenna element 109b. The radio backscatter signals 172, 173 are the same radio backscatter signals but received at different points. The lines representing the radio backscatter signals 172, 173 are parallel to each other. The first signal 172 makes an angle θ with a first line 174 that is normal to the plane of the antenna elements 109. The second signal 173 likewise makes an angle θ with a second line 175 that is normal to the plane of the antenna elements 109. The distance between the first line 174 and the second line 175 is represented as D 176 in FIG. 4. First line 174 is parallel to second line 175. The second signal 173 needs to travel a distance X further to reach the second antenna element 109b than the first signal 172 travels to reach the first antenna element 109a. The line segment 177 makes a right angle with the line of the second signal 173. Using well-known trigonometric relationships, the distance X is D sin(θ), where θ here is denominated in units of radians and where a 360-degree circle is 2TT radians around. The distance X can be expressed as a phase offset Δφ as expressed in EQ. 1 in FIG. 4. Angle θ, the direction to the RFID tag 104, can be determined using EQ. 2 in FIG. 4. Thus, the RFID tag reader 106 and/or the RFID tag reader application 114 can determine the direction to the RFID tag 104 based on the known wavelength ∧ of the radio backscatter signal, based on the known distance D between the antenna elements 109a, 109b, and based on the phase offset between the first radio backscatter signal 172 received at the first antenna element 109a and the second radio backscatter signal 173 received at the second antenna element 109b. It will be appreciated that the calculation of the direction and/or angle θ to the RFID tag 104 may be accomplished in a variety of different ways, and the present disclosure does not limit the invention to a specific mathematical implementation or specific equation for determining the direction to the RFID tag 104.

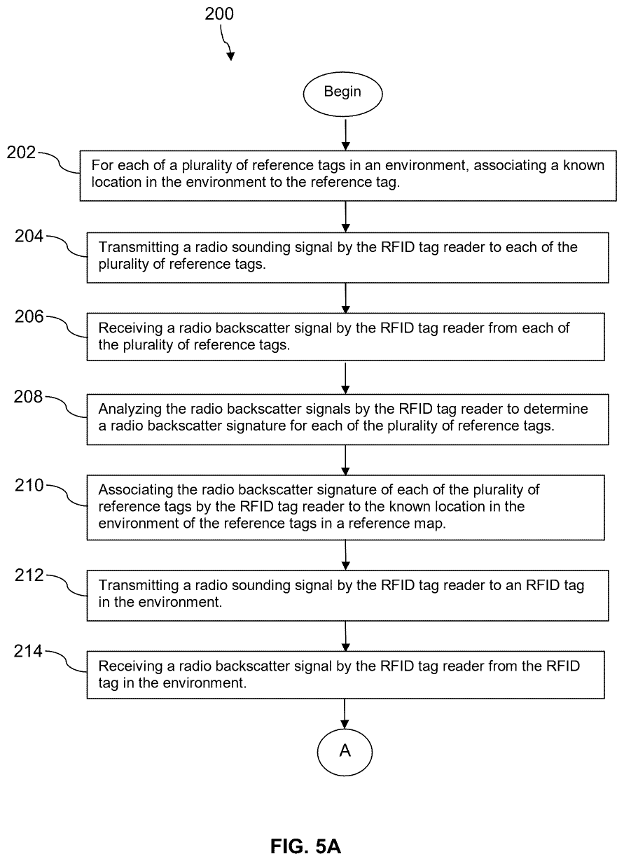

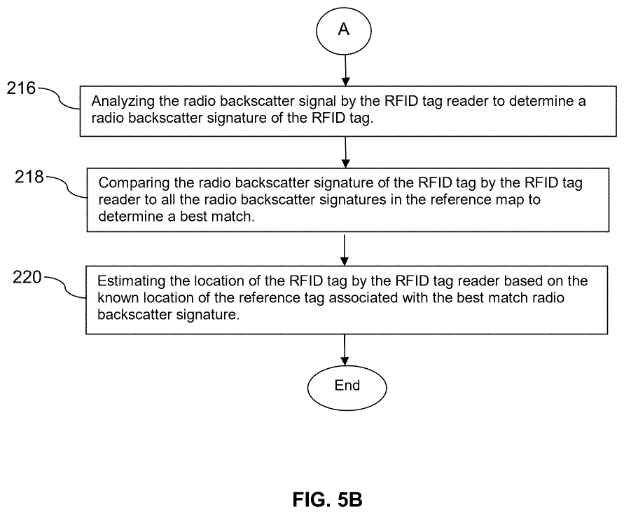

Turning now to FIG. 5A and FIG. 5B, a method 200 is described. In an embodiment, the method 200 is a method of locating radio frequency identity (RFID) tags by a RFID tag reader. At block 202, the method 200 comprises, for each of a plurality of reference tags in an environment, associating a known location in the environment to the reference tag. In an embodiment, the environment may be a warehouse or a fulfillment center.

At block 204, the method 200 comprises transmitting a radio sounding signal by the RFID tag reader to each of the plurality of reference tags. At block 206, the method 200 comprises receiving a radio backscatter signal by the RFID tag reader from each of the plurality of reference tags.

At block 208, the method 200 comprises analyzing the radio backscatter signals by the RFID tag reader to determine a radio backscatter signature for each of the plurality of reference tags. At block 210, the method 200 comprises associating the radio backscatter signature of each of the plurality of reference tags by the RFID tag reader to the known location in the environment of the reference tags in a reference map.

At block 212, the method 200 comprises transmitting a radio sounding signal by the RFID tag reader to an RFID tag in the environment. At block 214, the method 200 comprises receiving a radio backscatter signal by the RFID tag reader from the RFID tag in the environment.

At block 216, the method 200 comprises analyzing the radio backscatter signal by the RFID tag reader to determine a radio backscatter signature of the RFID tag. At block 218, the method 200 comprises comparing the radio backscatter signature of the RFID tag by the RFID tag reader to all the radio backscatter signatures in the reference map to determine a best match. At block 220, the method 200 comprises estimating a location of the RFID tag by the RFID tag reader based on the known location of the reference tag associated with the best match radio backscatter signature. In an embodiment, the reference tags are associated with product bins and estimating the location or the RFID tag comprises determining what product bin the RFID tag is located within. In an embodiment, the reference tags are spatially distributed throughout the environment. In an embodiment, the reference tags may be about equally distributed throughout at least part of the environment. In an embodiment, the location of the RFID tag is specified as a polar coordinate comprising a radial distance value and an angular value.

In an embodiment, backscatter signatures comprise an RSSI value and a direction. In an embodiment, the backscatter signatures may comprise a distance value (e.g., where the distance value is determined based on the RSSI value) and a direction. In an embodiment, instead of the direction, the backscatter signature may comprise a phase offset of a backscatter signal. In an embodiment, the method 200 comprises determining an estimated location of each reference tag based on the radio backscatter signature of the reference tag; and determining an offset between the estimated location of each reference tag and the known location of the reference tag, wherein estimating the location of the RFID tag is based on the radio backscatter signature of the RFID tag and based on the offset between the estimated location of the best match reference tag and the known location of the best match reference tag.

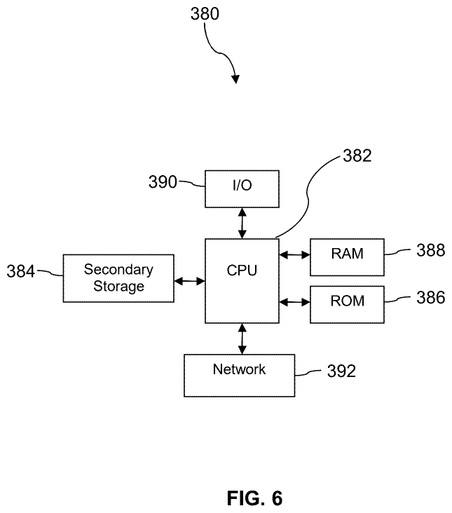

FIG. 6 illustrates a computer system 380 suitable for implementing one or more embodiments disclosed herein. The computer system 380 includes a processor 382 (which may be referred to as a central processor unit or CPU) that is in communication with memory devices including secondary storage 384, read only memory (ROM) 386, random access memory (RAM) 388, input/output (I/O) devices 390, and network connectivity devices 392. The processor 382 may be implemented as one or more CPU chips.

It is understood that by programming and/or loading executable instructions onto the computer system 380, at least one of the CPU 382, the RAM 388, and the ROM 386 are changed, transforming the computer system 380 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 380 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP) , time division multiplex (TDM), data over cable service interface specification (DOCSIS), wavelength division multiplexing (WDM), and/or the like. In an embodiment, the radio transceiver cards may provide wireless communication links using protocols such as code division multiple access (CDMA), global system for mobile communications (GSM), long-term evolution (LTE), WiFi (IEEE 802.11), Bluetooth, Zigbee, narrowband Internet of things (NB IoT), near field communications (NFC), radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk-based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 380 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 380 to provide the functionality of a number of servers that is not directly bound to the number of computers in the computer system 380. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 380, at least portions of the contents of the computer program product to the secondary storage 384, to the ROM 386, to the RAM 388, and/or to other non-volatile memory and volatile memory of the computer system 380. The processor 382 may process the executable instructions and/or data structures in part by directly accessing the computer program product, for example by reading from a CD-ROM disk inserted into a disk drive peripheral of the computer system 380. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 380.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 380 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

1. A radio frequency identity (RFID) tag reader, comprising:
an antenna;
a radio transceiver coupled to the antenna;
a memory;
a processor coupled to the radio transceiver and to the memory; and
an application stored in a non-transitory portion of the memory that, when executed by the processor,
directs sweeping a continuous beam of the antenna through an arc,
receives radio backscatter signals triggered at respective angles along the arc from an RFID tag by the sweeping beam, including a first radio backscatter signal from the RFID tag at a first angle with respect to the antenna defining a first direction from the antenna to the RFID tag,
analyzes the first radio backscatter signal to determine a first received signal strength indication (RSSI) of the first radio backscatter signal,
determines a distance from the RFID tag reader to the RFID tag based on the first RSSI, and
determines a location of the RFID tag based on the first direction and based on the distance from the RFID tag reader to the RFID tag.

2. The RFID tag reader of claim 1, wherein the application:
determines an RSSI of each of the radio backscatter signals from multiple angles along the arc, including the first RSSI of the first radio backscatter signal;
determines that the first RSSI of the first radio backscatter signal is the strongest RSSI of all the determined RSSIs of all the radio backscatter signals along the arc; and
determines the location of the RFID tag based further on the angle at which the strongest RSSI is determined.

3. The RFID tag reader of claim 1 wherein the location of the RFID tag is defined as a polar coordinate comprising a distance to the RFID tag and a direction to the RFID tag.

4. The RFID tag reader of claim 1, wherein the RFID tag reader transmits the location of the RFID tag to an inventory control application executing on a computer system, whereby the inventory control application is able to perform product inventory functions and order fulfillment functions.

5. The RFID tag reader of claim 1, wherein the antenna comprises more than three antenna elements and less than ten antenna elements.

6. The RFID tag reader of claim 5, wherein the antenna elements are dipole antenna elements.

7. The RFID tag reader of claim 5, wherein the antenna is a slot array antenna and the antenna elements are slots in the slot array antenna.

8. A method of locating radio frequency identity (RFID) tags by a RFID tag reader, comprising:
for each of a plurality of reference tags in an environment, associating a known location in the environment to the reference tag;
transmitting a radio sounding signal by the RFID tag reader to each of the plurality of reference tags;
receiving a radio backscatter signal by the RFID tag reader from each of the plurality of reference tags;
analyzing the radio backscatter signals by the RFID tag reader to determine a radio backscatter signature for each of the plurality of reference tags;
associating the radio backscatter signature of each of the plurality of reference tags by the RFID tag reader to the known location in the environment of the reference tags in a reference map;
transmitting a radio sounding signal by the RFID tag reader to an RFID tag in the environment;
receiving a radio backscatter signal by the RFID tag reader from the RFID tag in the environment;
analyzing the radio backscatter signal by the RFID tag reader to determine a radio backscatter signature of the RFID tag;
comparing the radio backscatter signature of the RFID tag by the RFID tag reader to all the radio backscatter signatures in the reference map to determine a best match; and
estimating a location of the RFID tag by the RFID tag reader based on the known location of the reference tag associated with the best match radio backscatter signature.

9. The method of claim 8, wherein the radio backscatter signatures comprise a radio signal strength indication (RSSI) and a direction.

10. The method of claim 8, further comprising determining an estimated location of each reference tag based on the radio backscatter signature of the reference tag; and determining an offset between the estimated location of each reference tag and the known location of the reference tag, wherein estimating the location of the RFID tag is based on the radio backscatter signature of the RFID tag and based on the offset between the estimated location of the best match reference tag and the known location of the best match reference tag.

11. The method of claim 8, wherein the reference tags are associated with product bins and estimating the location or the RFID tag comprises determining what product bin the RFID tag is located within.

12. The method of claim 8, wherein the reference tags are spatially distributed throughout the environment.

13. The method of claim 8, wherein the environment is one of a warehouse or a fulfillment center.

14. A radio frequency identity (RFID) tag reader, comprising:
an antenna that comprises a plurality of antenna elements;
a radio transceiver coupled to the antenna;
a memory;
a processor coupled to the radio transceiver and to the memory; and
an application stored in a non-transitory portion of the memory that, when executed by the processor,
transmits a radio sounding signal to an RFID tag,
receives a radio backscatter signal from the RFID tag,
analyzes the radio backscatter signal to determine a received signal strength indication (RSSI) of the backscatter signal,
analyzes the radio backscatter signal to determine a phase offset of the received radio backscatter signal, and
determines a location of the RFID tag based on the RSSI and the phase offset,
wherein the application determines the phase offset of the received radio backscatter signal by determining a phase offset between a first radio backscatter signal received at a first one of the plurality of antenna elements and a second radio backscatter signal received at a second one of the plurality of antenna elements.

15. The RFID tag reader of claim 14, wherein the radio transceiver is configured to transmit and receive in a frequency band that lies within an 860 MHz to 960 MHz frequency range.

16. The RFID tag reader of claim 14, wherein the radio transceiver is configured to transmit and receive in a frequency band that lies within an 860 MHZ to 870 MHz frequency range.

17. (canceled)

18. The RFID tag reader of claim 14, wherein the antenna comprises more than three antenna elements and less than ten antenna elements.

19. (canceled)

20. The RFID tag reader of claim 14, wherein the application determines a distance to the RFID tag based on the RSSI of the received backscatter signal; wherein the application determines a direction to the RFID tag based on the phase offset of the received backscatter signal, based on a wavelength of the received backscatter signal, and based on a distance between a first one of the plurality of antenna elements and a second one of the plurality of antenna elements; and wherein the application determines the location of the RFID tag as a polar coordinate comprising the distance to the RFID tag and the direction to the RFID tag.

21. The RFID tag reader of claim 14, wherein the application, when executed by the processor, further:
analyzes the radio backscatter signal by the RFID tag reader to determine a radio backscatter signature of the RFID tag;
associates a known location to the RFID tag;
associates the radio backscatter signature to the known location in a reference map;
matches the radio backscatter signature of the RFID tag by the RFID tag reader to the radio backscatter signature in the reference map; and
estimates a location of the RFID tag by the RFID tag reader based on the known location associated with the matched radio backscatter signature.

22. The RFID tag reader of claim 1, wherein analyzing the first radio backscatter signal includes determining a radio backscatter signature for the RFID tag, the radio backscatter signature comprising the RSSI and first direction, and the application, when executed by the processor, further:
associates a known location to the RFID tag;
associates the radio backscatter signature to the known location in a reference map;
analyzes the radio backscatter signal by the RFID tag reader to determine a radio backscatter signature of the RFID tag;
matches the radio backscatter signature of the RFID tag by the RFID tag reader to the radio backscatter signature in the reference map; and
estimates a location of the RFID tag by the RFID tag reader based on the known location associated with the matched radio backscatter signature.
